(19) United States
(12) Patent Application Publication
(10) Pub. No.: US 2026/0170141 A1
(43) Pub. Date: Jun. 18, 2026

(54) SECURITY ENSURING APPARATUS, SECURITY ENSURING METHOD, AND COMPUTER-READABLE RECORDING MEDIUM

(71) Applicant: NEC Corporation, Minato-ku, Tokyo (JP)

(72) Inventors: Kazuhiko ISOYAMA, Tokyo (JP); Junpei KAMIMURA, Tokyo (JP); Shun MIYAZAKI, Tokyo (JP); Jun KODAMA, Tokyo (JP)

(73) Assignee: NEC Corporation, Minato-ku, Tokyo (JP)

(21) Appl. No.: 18/710,656

(22) PCT Filed: Dec. 7, 2021
(86) PCT No.: PCT/JP2021/044865

§ 371 Date: May 16, 2024

(51) Int. Cl. G06F 21/57; G06F 21/55

(52) U.S. Cl. CPC G06F 21/577; G06F 21/554; H04L 63/20

(57) ABSTRACT

A security ensuring apparatus includes: an obtaining unit that obtains scenario information generated in order to detect a risk in a first system, first data flow information generated based on first history information obtained by an agent of the first system and indicating a flow of data in the first system, rule information for performing risk analysis on the first data flow information, and first analysis result information indicating a result of risk analysis on the first system; a generation unit that generates second data flow information indicating a flow of data in a second system based on second history information obtained by the agent, after an attack is executed on the second system based on the scenario information; and an analysis unit that performs risk analysis using the second data flow information and the rule information.

### TECHNICAL FIELD

The technical field relates to a security ensuring apparatus and a security ensuring method for perfor ming analysis on the security risk of a system, and in particular relates to a computer-readable recording medium on which a program for realizing the apparatus and method is recorded.

### BACKGROUND ART

When a developed system is transferred to a user such as an end user or a secondary developer, and the developed system is modified by the user at a transfer destination or a method for using the system is changed, it is not possible to ensure the security quality of an additionally developed system (transferred system). In view of this, there is demand for reconducting security risk analysis (for example, vulnerability check) conducted on the developed system, at a transfer destination.

However, when a developed system is modified or a method for using the system is changed, conventional risk analysis such as binary check and code check conducted on the developed system cannot be reconducted.

As a related technique, Patent Document 1 discloses a vulnerability risk diagnosis system for performing diagnosis for a risk of vulnerability. The vulnerability risk diagnosis system in Patent Document 1 registers vulnerability information publicized from a vendor and incident information for each system device, collates the registered vulnerability information and incident information with each other, and executes risk diagnosis of the system device with respect to vulnerability.

### LIST OF RELATED ART DOCUMENTS

### Patent Document

Patent Document 1: Japanese Patent Laid-Open No. 08-006783

### SUMMARY OF INVENTION

### Problems to be Solved by the Invention

However, the vulnerability risk diagnosis system in Patent Document 1 only conducts risk diagnosis on a developed system, and does not envision risk diagnosis of an additionally developed system at a transfer destination. Therefore, risk diagnosis conducted on the developed system cannot be reconducted for the additionally developed system.

As an aspect, an example object is to provide a security ensuring apparatus, a security ensuring method, and a computer-readable recording medium that enable risk analysis conducted on a developed system to be reconducted on a system additionally developed at a transfer destination.

In order to achieve the example object described above, a security ensuring apparatus according to an example aspect includes:
an obtaining unit that obtains scenario information generated in order to detect a risk in a first system, first data flow information generated based on first history information obtained by an agent of the first system and indicating a flow of data in the first system, rule information for performing risk analysis on the first data flow information, and first analysis result information indicating a result of risk analysis on the first system;
a generation unit that generates second data flow information indicating a flow of data in a second system based on second history information obtained by the agent, after an attack is executed on the second system based on the scenario information; and
an analysis unit that performs risk analysis using the second data flow information and the rule information.

Also, in order to achieve the example object described above, a security ensuring method that is performed by a computer according to an example aspect includes:
obtaining scenario information generated in order to detect a risk in a first system, first data flow information generated based on first history information obtained by an agent of the first system and indicating a flow of data in the first system, rule information for performing risk analysis on the first data flow information, and first analysis result information indicating a result of risk analysis on the first system;
generating second data flow information indicating a flow of data in a second system based on second history information obtained by the agent, after an attack is executed on the second system based on the scenario information; and
performing risk analysis using the second data flow information and the rule information.

Furthermore, in order to achieve the example object described above, a computer-readable recording medium according to an example aspect includes a program recorded on the computer-readable recording medium, the program including instructions that cause the computer to carry out:
obtaining scenario information generated in order to detect a risk in a first system, first data flow information generated based on first history information obtained by an agent of the first system and indicating a flow of data in the first system, rule information for performing risk analysis on the first data flow information, and first analysis result information indicating a result of risk analysis on the first system:
generating second data flow information indicating a flow of data in a second system based on second history information obtained by the agent, after an attack is executed on the second system based on the scenario information; and
performing risk analysis using the second data flow information and the rule information.

### Advantageous Effects of the Invention

As an aspect, the risk analysis performed by the developed system can be reconducted on a system additionally developed at a transfer destination.

### BRIEF DESCRIPTION OF THE DRAWINGS

FIG. 1 is a diagram for describing an example of a security ensuring apparatus.

FIG. 2 is a diagram for describing an example of a system that includes the security ensuring apparatus.

FIG. 3 is a diagram for describing an example of scenario information.

FIG. 4 is a diagram for describing data flow information.

FIG. 5 is a diagram for describing an example of rule information.

FIG. 6 is a diagram for describing risk analysis.

FIG. 7 is a diagram for describing an example of first analysis result information.

FIG. 8 is a diagram for describing an example of second analysis result information.

FIG. 9 is a diagram for describing an example of examination result information.

FIG. 10 is a diagram for describing an example of operations of the security ensuring apparatus.

FIG. 11 is a diagram for describing an example of security ensuring information.

FIG. 12 is a block diagram showing an example of a computer that realizes a security ensuring apparatus.

### EXAMPLE EMBODIMENT

First, an overview will be given for ease of understanding of an example embodiment to be described later.

Usually, when a system (first system) developed by a developer is to be transferred to a transfer destination (for example, an end user or a secondary developer), risk analysis is performed on the developed system, and after it is determined that there is no risk, the developed system is transferred to the transfer destination.

However, if risk analysis that is to be conducted on the system (second system) additionally developed at the transfer destination is checking that uses a natural language, there are cases where checking conducted during development cannot be conducted. In addition, if the system is modified at the transfer destination or a method for using the system is changed (additionally developed), the security quality of the additionally developed system cannot be ensured.

Through such processes, the inventors found an issue of ensuring security quality of even an additionally developed system, and also derived a means for solving the issue.

That is to say, the inventors came to derive a means that enables risk analysis conducted during development to be conducted for an additionally developed system. As a result, risk analysis conducted during development can be reproduced for an additionally developed system, and thus the security quality of a transferred system can also be ensured.

An example embodiment will be described below with reference to the drawings. Note that, in the drawings which will be described below, the same functions or constituent elements that have corresponding functions are given the same reference numerals, and a repeated description thereof may be omitted.

### EXAMPLE EMBODIMENT

A security ensuring apparatus for ensuring the security quality of an additionally developed system will be described. The security ensuring apparatus is an apparatus that enables risk analysis conducted on a developed system (first system) to be reconducted for a system (second system) additionally developed at a transfer destination.

### Apparatus Configuration

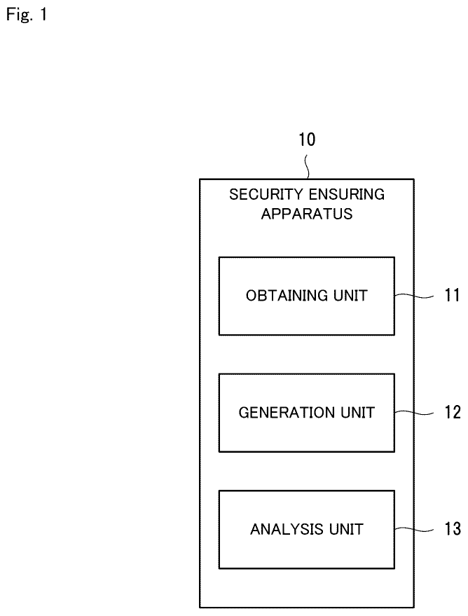

FIG. 1 is a diagram for describing an example of a security ensuring apparatus. A security ensuring apparatus 10 includes an obtaining unit 11, a generation unit 12, and an analysis unit 13.

The obtaining unit 11 obtains scenario information, first data flow information, rule information, and first analysis result information, which have been used for risk analysis of a first system.

Specifically, the obtaining unit 11 obtains the scenario information, the first data flow information, the rule information, and the first analysis result information, which are stored in a storage device by a first risk analysis apparatus that conducted risk analysis on the first system.

The scenario information is a scenario generated in order to detect a risk in the first system. The first data flow information is information (information indicating a data flow diagram) indicating flow of data in the first system generated based on first history information obtained by an agent of the first system.

The rule information is information for performing risk analysis in the first data flow information (information indicating a data flow diagram). The first analysis result information is information indicating a result of risk analysis in the first system.

Note that the scenario information, the first data flow information, the rule information, and the first analysis result information may be stored in the storage device in association with each other as security ensuring information for ensuring the security of the first system.

After an attack is executed on a second system based on the scenario information, the generation unit 12 generates second data flow information based on second history information obtained by an agent.

Specifically, the security ensuring apparatus 10 first installs, to the second system, an agent that has functions that are equivalent to those of the agent used by the developer, and causes the agent to start collecting processing. Next, an attack is executed based on the scenario information, and during a period that includes an attack execution period, the installed agent obtains second history information from the second system. The generation unit 12 then generates second data flow information based on the obtained second history information.

The second data flow information is information indicating flow of data in the second system generated based on the second history information obtained by the agent of the second system.

The analysis unit 13 performs risk analysis using the second data flow information and the rule information. Specifically, first, the analysis unit 13 obtains the second data flow information and the rule information. Next, the analysis unit 13 executes collation processing (matching processing) using the rule information and the second data flow information.

Matching processing is processing for detecting a portion (information indicating flow of data: pattern) of the second data flow information (information indicating a data flow diagram) that matches the rule information (information indicating a data flow diagram), for example.

Next, if it is determined, as a result of collation, that no portion of the second data flow information matches the rule information, the analysis unit 13 determines that there is no risk in the second system with respect to the rule information. In contrast, if it is determined that a portion of the second data flow information matches the rule information, the analysis unit 13 determines that there is the possibility of a risk in the second system with respect to the rule information.

Furthermore, after performing risk analysis using the second data flow information and the rule information, the analysis unit 13 generates second analysis result information indicating a result of risk analysis in the second system.

As described above, in the example embodiment, risk analysis conducted on the first system can be reconducted for the second system by using the scenario information and the rule information used for the first system.

In addition, by comparing the first analysis result information of the developer with the second analysis result information at the transfer destination, it is possible to detect that the first system has been modified or a method for using the first system has been changed. As a result, the security quality of the second system can be ensured.

### System Configuration

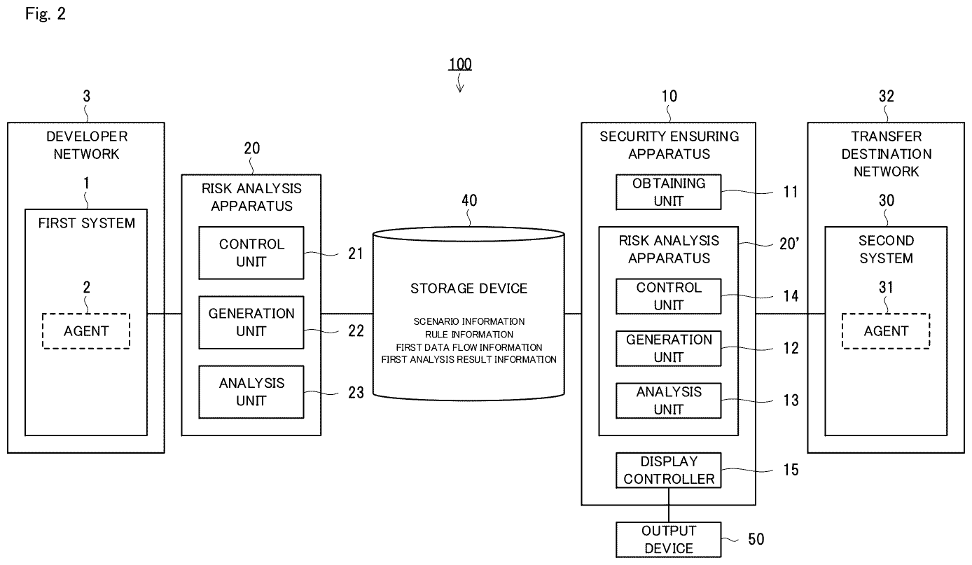

FIG. 2 is a diagram for describing an example of a system that includes the security ensuring apparatus. A system 100 shown in FIG. 2 includes a first system 1 and a risk analysis apparatus 20, which were developed in a development environment (a developer network 3) of a developer, a second system 30 and the security ensuring apparatus 10 developed in a development environment (a transfer destination network 32) at a transfer destination, a storage device 40, and an output device 50.

The risk analysis apparatus 20 is an apparatus for determining whether or not there is a security risk based on flow of data in the first system 1. The risk analysis apparatus 20 is connected to the first system 1 and the storage device 40 via a network or the like.

The risk analysis apparatus 20 is an information processing apparatus such as a CPU (Central Processing Unit), a programmable device such as an FPGA (Field-Programmable Gate Array), a GPU (Graphics Processing Unit), or a circuit, a server computer, a personal computer or a mobile terminal in which one or more thereof are mounted.

The first system 1 is a developed system that is analyzed by the developer. The first system 1 is constituted by devices such as a server computer, a terminal apparatus, and a database. An authentication system or the like is conceivable as the first system 1, for example. Note that the first system 1 is not limited to an authentication system.

The network is an ordinary network constructed using a communication line such as the Internet, a LAN (Local Area Network), a dedicated line, a phone line, an intranet, a mobile communication network, Bluetooth (registered trademark), or WiFi (Wireless Fidelity).

The storage device 40 is a device that stores scenario information, rule information, first data flow information, and first analysis result information. The storage device 40 is a device such as a server computer, a database, or a memory. In the example in FIG. 2, the storage device 40 is provided outside the risk analysis apparatus 20, but may be provided outside the risk analysis apparatus 20.

The risk analysis apparatus of the developer will be described in detail.

As shown in FIG. 2, the risk analysis apparatus 20 includes a control unit 21, a generation unit 22, and an analysis unit 23.

The control unit 21 controls installation and uninstallation of an agent 2 that executes collecting processing for collecting first history information from the first system 1. The control unit 21 performs control for causing the installed agent 2 to start collecting first history information and to stop collecting first history information.

The first history information is information related to data that is generated as a result of a program being executed in the first system 1, data that is transmitted/received in the first system 1, and the like. The first history information is a system call, snapshot, or the like. The program is an authentication program if the first system 1 is an authentication system.

The control unit 21 obtains the scenario information stored in the storage device 40, and executes one or more types of processing (for example, an attack scenario) on the first system 1 based on the scenario information. Specifically, after collecting processing by the agent 2 installed in the first system 1 is started, the control unit 21 causes one or more types of processing stated in the scenario information (for example, a test code) to be started.

Subsequently, after the plurality of types of processing stated in the test codes end, and access right information to be described later is obtained, the control unit 21 causes the agent 2 to end collecting processing, and uninstalls the agent 2.

The scenario information is a test code created for the purpose of examining an operation of the first system 1, or the like. In the case of an authentication system, processing for passing user information received by a server computer to another server computer, processing for performing, in the other server computer, user authentication on the user information received from the server computer, processing for storing, in a database, user information of a user authenticated by the server computer and managing the stored user information, and the like are conceivable as the above processing.

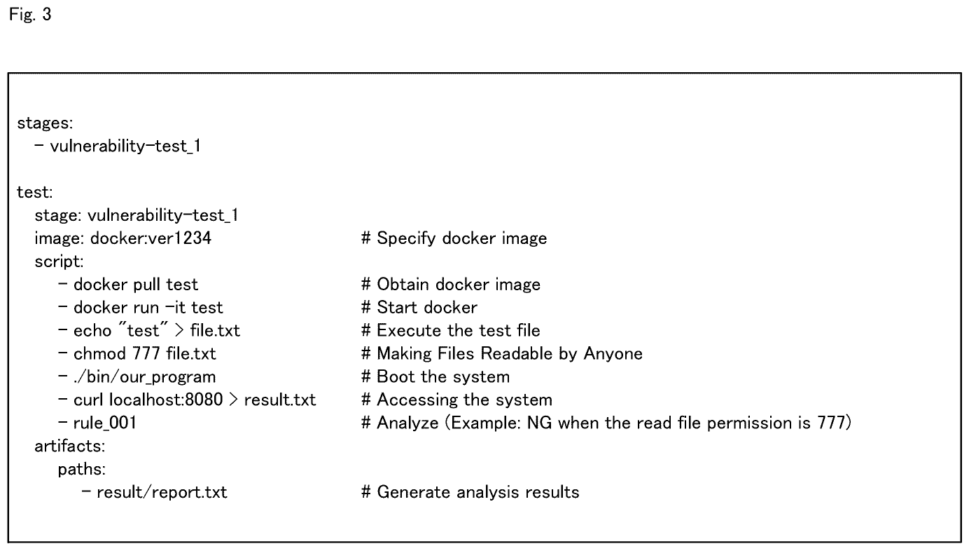

FIG. 3 is a diagram for describing an example of the scenario information. FIG. 3 shows a scenario stated in the Docker language. Statement of the test code in FIG. 3 is partially omitted for ease of understanding.

The scenario in FIG. 3 is a test code for setting the authority of a file to “full authority”. In accordance with the statement of the test code in FIG. 3, first, an image is downloaded from a registry. Next, Docker is started, and a test file is executed.

Next, in accordance with the statement “chmod 777 file.txt”, the authority of the file is set to “full authority”. Next, the first system 1 is started, and in accordance with the statement “curl localhost:8080>result.txt”, the first system 1 accesses the file.

Next, in accordance with the statement “rule_001”, risk analysis is executed using a later-described rule “rule_001”. A later-described analysis result is then generated using the result of risk analysis.

In addition, the control unit 21 obtains first access right information of the file accessed by a program executed based on the scenario information. The first access right information is information related to an access authority set in the file accessed by the program that is executed in the first system 1.

The generation unit 22 has functions that are equivalent to those of the generation unit 12 described above. Specifically, the generation unit 22 first generates first data flow information indicating flow of data in the first system 1 based on first history information, or the first history information and the first access right information. The first data flow information is automatically generated using a known technique or the like.

The agent 2 collects information such as information such as which file being accessed in which process, which process being started, and which socket being used to perform communication, using sysdig or Audit in the case of Linux (registered trademark) and ETW (Event Tracing for Windows) in the case of Windows, for example. Data flow between processes, files, and sockets is grasped based on such information, and data flow information is generated.

The first data flow information includes node information and flow information. The flow information is information indicating flow of data between nodes (elements) (information indicating a data flow diagram). Flow identification information for identifying flow, start point node information indicating a node that is a start point, and end point node information indicating a node that is an end point are included, for example.

The flow identification information is information indicating processing caused by communication performed between elements (information related to flow of data), for example. Information regarding reading, writing, transmission, receiving, start, stop, and the like of a file are conceivable as the flow identification information, for example. Note that the flow identification information is not limited to the above information.

The node information includes information indicating elements such as process information, data storage information, and origin/terminator information. The process information is information indicating processing of data. The data storage information is information indicating a storage location of temporary data. The data storage information is information indicating a file, a database, or the like. The origin/terminator information is information indicating a person, an organization, or the like outside the analysis target system. An origin is an element that brings data to the analysis target system. A terminator is an element that receives data from the analysis target system.

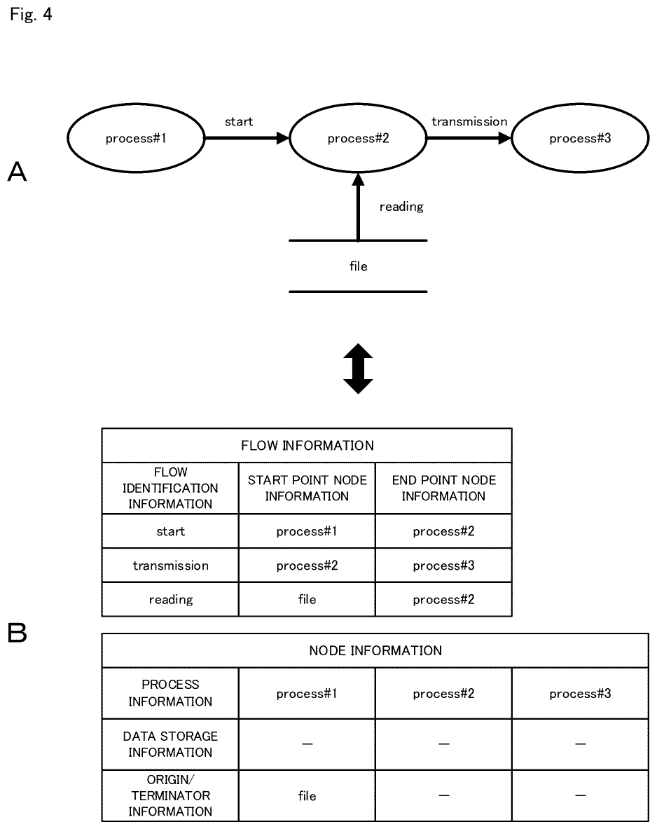

FIG. 4 is a diagram for describing data flow information. FIG. 4A is a diagram showing a data flow diagram. FIG. 4B is a diagram showing data flow information used for creating the data flow diagram in FIG. 4A. The example in FIG. 4 shows a flow indicating that process #1starts process #2, a flow indicating that process #2 transmits data to process #3, and a flow indicating that process #2 reads out data from a file.

Note that a table is used in the example in FIG. 4, but data flow is not limited to a table, and it suffices for the data flow to be stated so as to indicate a data flow diagram. The data flow may be stated based on a relational database, a graph database, or the like.

The analysis unit 23 has functions that are equivalent to those of the above analysis unit 13. The analysis unit 23 refers to the first data flow information, and using the rule information stored in the storage device 40, determines whether or not there is a risk in the first data flow information (whether or not there is a security risk in the first data flow information).

The rule information is information for detecting a risk in the first data flow information. The rule information includes one or more rules (determination conditions). Note that a rule is manually or automatically generated based on a check sheet (rule statement specification) for checking whether or not there is vulnerability in the first system 1, for example.

Note that the check sheet is generated based on information disclosed with respect to vulnerability of a system or an incident such as CVE (Common Vulnerabilities and Exposures) and CWE (Common Weakness Enumeration).

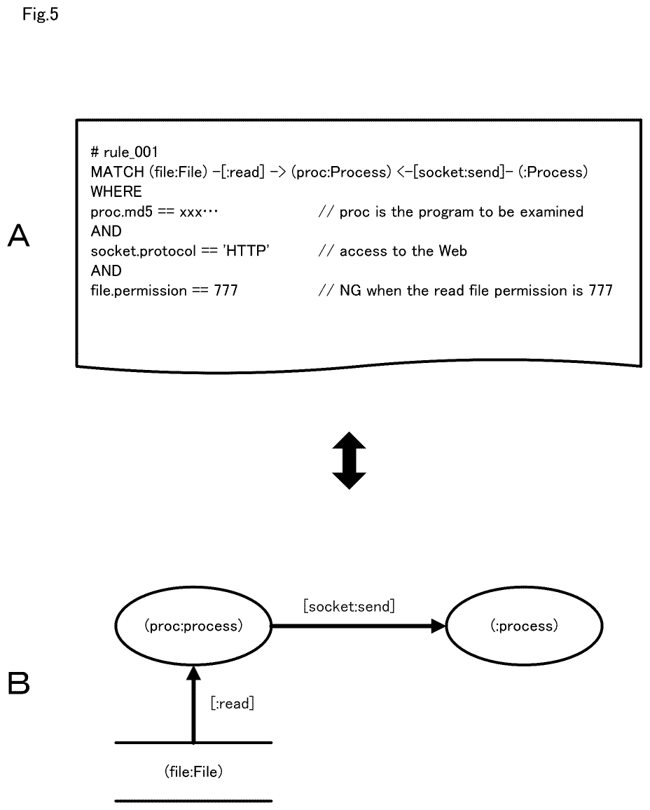

FIG. 5 is a diagram for describing an example of the rule information. FIG. 5A is a diagram showing an example of statement of a rule. Note that the statement in FIG. 5A is a rule stated in the Cypher language. FIG. 5B is a diagram in which a data flow diagram indicates the statement in FIG. 5A. Note that the statement in FIG. 5A is partially omitted for ease of description.

In FIG. 5A, a rule named “rule_001” is stated. Statement of the MATCH phrase in FIG. 5A indicates a pattern (data flow diagram) such as that shown in FIG. 5B, using node information and flow information.

In addition, the MATCH phrase includes identifiers “file”, “proc”, and “socket” for referencing using the WHERE phrase. In addition, “: File” represents data storage information, “: read” represents flow identification information indicating reading, “: Process” represents process information, and “socket: send” represents flow identification information indicating transmission of a socket.

As described in the comment in FIG. 5A, statement “proc.md5==xxx . . . ” indicates that “proc” is an analysis target program. “socket. Protocol==‘HTTP’” indicates access to the Web. “file. permission==777” indicates that permission of the file is set to 777. Permission being 777 indicates full authority. That is to say, there is vulnerability.

Note that the Cypher language is used in the example in FIG. 5, but statement of a rule is not limited to the Cypher language, and it suffices for a rule to be stated such that a risk can be detected from data flow information.

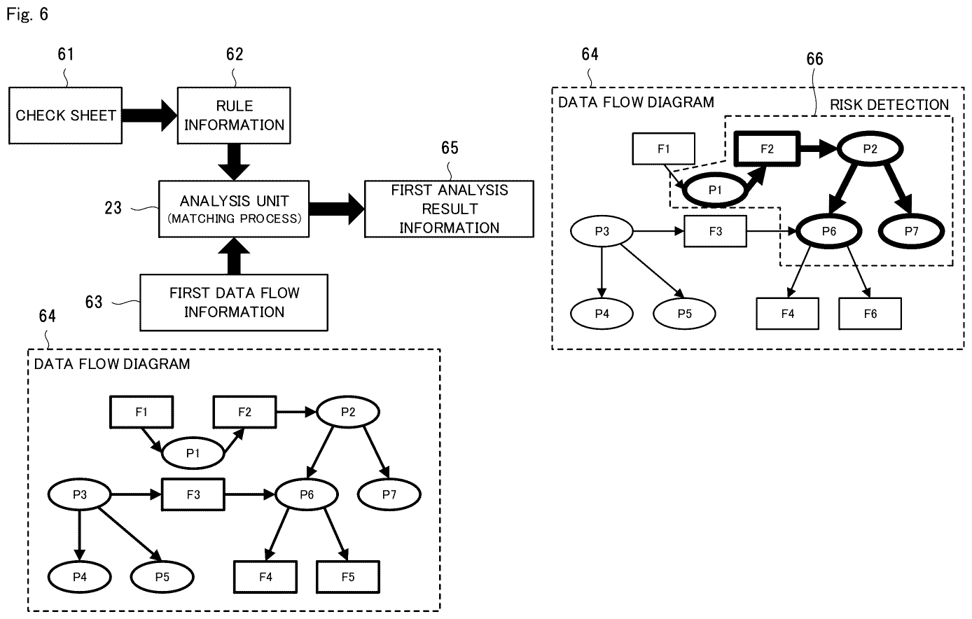

FIG. 6 is a diagram for describing risk analysis. The analysis unit 23 first obtains rule information 62 generated based on a risk check sheet 61, and first data flow information 63. Note that, in the example in FIG. 6, for ease of description, a data flow diagram 64 of the first data flow information 63 is auxetically shown.

Next, the analysis unit 23 determines whether or not a portion of a pattern (information indicating a data flow diagram) defined in the first data flow information 63 matches a pattern (information indicating a data flow diagram) defined in a rule of the rule information 62.

When a portion of the first data flow information 63 matches the rule, the analysis unit 23 determines that there is the possibility of a risk in the portion that matches the rule.

In the example in FIG. 6, risk detection 66 in the data flow diagram 64 (broken line area) indicates a portion that matches a rule.

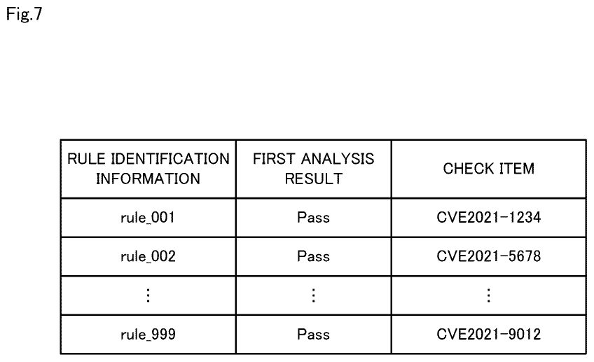

Next, the analysis unit 23 generates first analysis result information 65 based on the above detection result. FIG. 7 is a diagram for describing an example of the first analysis result information. “Rule identification information” of the first analysis result information in FIG. 7 stores “rule_001”, “rule_002” . . . “rule_999” indicating the names of rules. “First analysis result” in FIG. 7 stores results of risk analysis of the first system 1. In the example in FIG. 7, “Pass” is stored as a result of risk analysis. “Pass” indicates that there is no portion that matches the rule. “Check item” in FIG. 7 stores check items “CVE2021-1234”, “CVE2021-5678” . . . “CVE2021-9012” of a check sheet that are the basis of the rules. Note that the developer performs debugging until all of the rules change to “pass”.

The security ensuring apparatus at the transfer destination will be described in detail.

The security ensuring apparatus 10 is an apparatus that determines whether or not there is a security risk based on a flow of data in the second system 30, and ensures the security quality of the second system 30 based on the determination result.

The security ensuring apparatus 10 is connected to the storage device 40, the second system 30, and the output device 50 via a network or the like.

The second system 30 is a system that is an analysis target at the transfer destination. The second system 30 is constituted by devices such as a server computer, a terminal apparatus, and a database, for example. An authentication system or the like is conceivable as the second system 30. Note that the second system 30 is not limited to an authentication system.

The network and the storage device 40 have already described, and thus a description of the network and the storage device 40 is omitted.

The output device 50 obtains output information subjected to conversion into a format that can be output, and outputs a generated image and sound and the like based on the output information. The output device 50 is an image display device that uses a liquid crystal display, an organic EL (electro luminescence) display, a CRT (Cathode Ray Tube), or the like. Furthermore, the image display apparatus may be provided with a sound output device such as a speaker. Note that the output device 50 may also be a print apparatus such as a printer.

The security ensuring apparatus 10 is an information processing apparatus such as a CPU (Central Processing Unit), a programmable device such as an FPGA (Field-Programmable Gate Array), a GPU (Graphics Processing Unit), or a circuit, a server computer, a personal computer, or a mobile terminal in which one or more thereof are mounted.

As shown in FIG. 2, the security ensuring apparatus 10 includes the obtaining unit 11, a risk analysis apparatus 20′, and an examination unit 15.

The obtaining unit 11 obtains, from the storage device 40, the scenario information, the first data flow information, the rule information, and the first analysis result information, which have been used for risk analysis of the first system 1. Specifically, the obtaining unit 11 obtains security ensuring information.

The risk analysis apparatus 20′ has functions that are equivalent to those of the above risk analysis apparatus 20. The risk analysis apparatus 20′ includes a control unit 14, a generation unit 12, and an analysis unit 13.

The control unit 14 has functions that are equivalent to those of the above control unit 21. The control unit 14 controls installation and uninstallation of an agent 31 that executes collecting processing for collecting second history information from the second system 30. The control unit 14 performs control for causing the installed agent 31 to start processing for collecting second history information and to end the processing. The agent 31 has functions that are equivalent to those of the above agent 2.

The control unit 14 obtains the scenario information stored in the storage device 40, and executes one or more types of processing on the second system 30 based on the scenario information. Specifically, after collecting processing by the agent 31 installed in the second system 30 is started, the control unit 14 causes the one or more types of processing stated in the scenario information (for example, a test code) to be started.

Subsequently, after the plurality of types of processing stated in the test code end, and later-described access right information is obtained, the control unit 14 causes the agent 31 to end collecting processing, and uninstalls the agent 31.

In addition, the control unit 14 obtains second access right information of a file accessed by a program executed based on the scenario information. The second access right information is information regarding an access authority set in the file accessed by the program that is executed in the second system 30.

The generation unit 12 first generates second data flow information indicating a flow of data in the second system 30, based on second history information, or the second history information and the second access right information. The second data flow information is automatically generated using a known technique or the like.

The second data flow information includes node information and flow information. Note that the node information and the flow information have already been described, and thus a description of the node information and the flow information is omitted.

Note that, when the second system 30 is modified or a method for using the system is changed, there is the possibility that the content of the second data flow information differs from the content of the first data flow information.

The analysis unit 13 refers to the second data flow information by using the rule information stored in the storage device 40, determines whether or not there is a risk in the second data flow information (whether or not there is a security risk in data flow information).

Specifically, the analysis unit 13 collates the rule information (information indicating a data flow diagram) with the second data flow information (information indicating a data flow diagram), and, if no portion of the second data flow information matches the rule information, the analysis unit 13 determines that there is no risk in the second system 30 with respect to the rule information.

As described above, if a portion of the second data flow information matches the rule information, the analysis unit 13 determines that there is the possibility of a risk in the second system 30 with respect to the rule information.

Next, if it is determined that there is the possibility of a risk in the second system 30 with respect to the rule information, the analysis unit 13 further determines whether or not node information included in data flow information of the matched portion matches node information of corresponding first data flow information. Determination is performed on whether or not the file has been rewritten or the like, for example.

When the entire node information included in the data flow information of the matched portion matches the node information of the corresponding first data flow information, the analysis unit 13 determines that there is a risk in the second system 30 with respect to the rule information (“Fail”). That is to say, matching with the same rule as the first system 1 is obtained, and thus it is determined that there is also a risk in the second system 30. It is conceivable that the cause of “Fail” is a mistake of the developer since there is a risk on the same condition as that of the developer.

If a portion or the entirety of the node information included in the data flow information of the matched portion does not match the node information of the corresponding first data flow information, the analysis unit 13 determines that there is a risk in the second system 30 with respect to the rule information, but the usage situation is different from that of the first system 1 (“NA”). It is conceivable that, as the cause of “NA”, the risk was caused by additional development at the transfer destination.

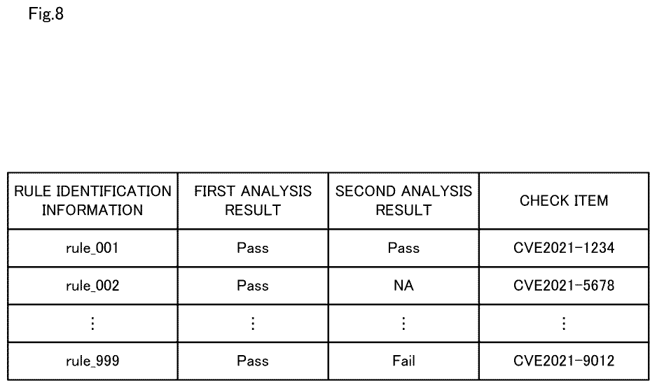

Next, the analysis unit 13 generates second analysis result information based on the above detection result. FIG. 8 is a diagram for describing an example of second analysis result information. “Rule identification information” of the second analysis result information in FIG. 8 stores “rule_001”, “rule_002” . . . “rule_999” indicating the names of rules. “First analysis result” in FIG. 8 stores results of risk analysis of the first system 1. In the example in FIG. 8, “Pass” is stored as results of risk analysis. “Pass” indicates that no portion matches the rule.

“Second analysis result” in FIG. 8 stores results of risk analysis of the second system 30. In the example in FIG. 8, “Fail” that is information indicating that there is the possibility of a risk in the second system 30 is stored.

“NA” is information indicating that, when there is the possibility of a risk in the second system 30, the node information included in the data flow information of the matched portion partially differs from the node information of the corresponding first data flow information.

In addition, “check item” in FIG. 8 stores check items “CVE2021-1234”, “CVE2021-5678” . . . “CVE2021-9012” of a check sheet that are basis of the rules.

The examination unit 15 generates examination result information (output information) to be output to the output device 50, using the second analysis result information generated by the analysis unit 13, and outputs the generated examination result information to the output device 50. As the examination result information, at least time, date, month, and year when analysis was performed and second analysis results of the second analysis result information are output to the output device 50.

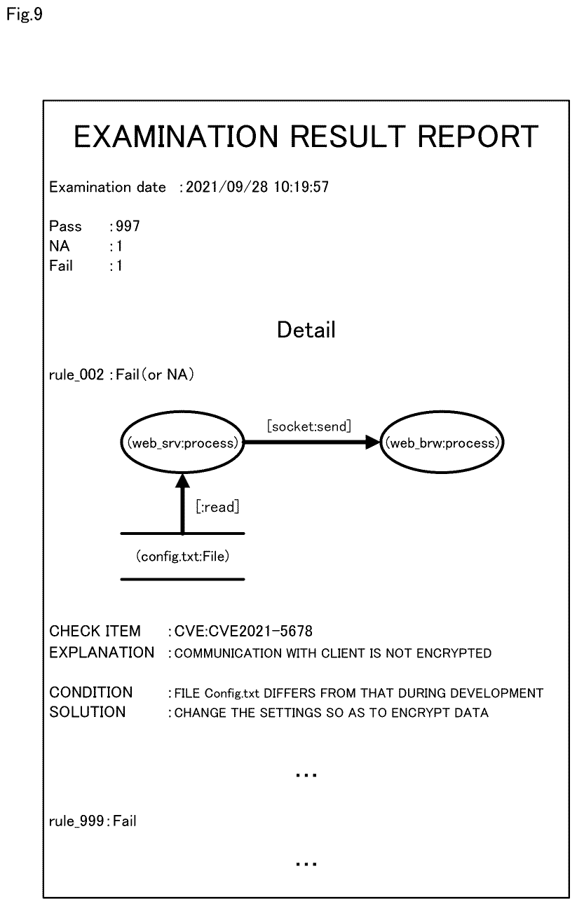

FIG. 9 is a diagram for describing an example of examination result information. As shown in FIG. 9, for example, detailed information may be output to the output device 50 in addition to time, date, month, and year, and the aggregated result of the second analysis results. The detailed information includes rule identification information of a rule with respect to which a risk is determined to be present, a data flow diagram corresponding to the rule, a check item corresponding to the rule, description of the check item, and the like.

In the example in FIG. 9, “2021/09/28 10:19:57” is displayed as an analysis day, and “Pass: 997”, which is the total of “Pass”, is displayed as an aggregated result, and “NA:1”, which is the total of “NA”, and “Fail: 1”, which is the total of “Fail”, are displayed.

In addition, in the example in FIG. 9, rule identification information “rule_002” and “rule_999”, a data flow diagram of “rule_002”, the check item “CVE: CVE2021-5678” corresponding to the rule, and description of the check item “communication with client is not encrypted” are displayed as detailed information.

Furthermore, condition information indicating the difference in node between the developer and the transfer destination, and solution information indicating a method for solving a risk may be displayed as the detailed information. In the example in FIG. 9, “file config. txt differs from that during development” is displayed as the condition information. In addition, in the example in FIG. 9, “change the settings so as to encrypt data” is displayed as the solution information.

### Apparatus Operation

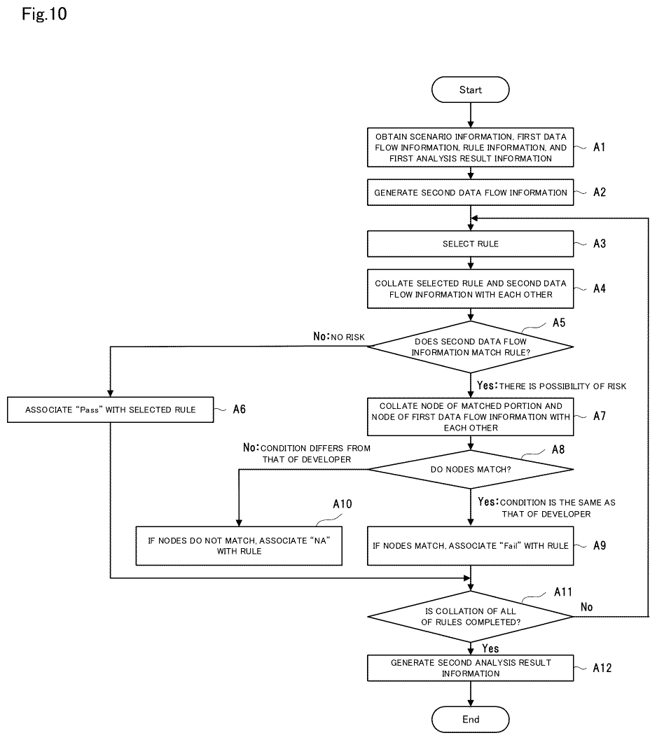

Operations of the security ensuring apparatus 10 will be described. FIG. 10 is a diagram for describing an example of operations of the security ensuring apparatus. In the following description, drawings are referenced as appropriate. In addition, in the example embodiment, a security ensuring method is performed by the security ensuring apparatus operating. Thus, description of the security ensuring method according to an example embodiment is replaced by the following description of operations of the security ensuring apparatus.

The obtaining unit 11 first obtains scenario information, first data flow information, rule information, and first analysis result information (step A1). Specifically, in step A1, the obtaining unit 11 obtains security ensuring information.

Next, after an attack is executed on the second system 30 based on the scenario information, the generation unit 12 generates second data flow information based on second history information obtained by the agent (step A2).

Next, the analysis unit 13 selects a rule from the rule information (step A3). Next, the analysis unit 13 executes matching processing (collation) using the selected rule (information indicating a data flow diagram) and second data flow information (information indicating a data flow diagram) (step A4).

Next, if no portion of the second data flow information matches the selected rule (step A5: No), the analysis unit 13 determines that there is no risk in the second system 30 with respect to the selected rule information. In that case, the analysis unit 13 associates the selected rule with “Pass” indicating that no portion of the second data flow information matches the selected rule (step A6).

In addition, if a portion of the second data flow information matches the selected rule (step A5: Yes), the analysis unit 13 determines that there is the possibility of a risk in the second system 30 with respect to the rule information. In that case, the analysis unit 13 collates a node included in the matched portion (pattern) and a node of the first data flow information with each other (step A7).

Next, if the node included in the portion that matches the selected rule matches the node of the corresponding portion of the first data flow information (step A8: Yes), the analysis unit 13 determines that there is a risk in the second system 30, and associates “Fail” with the selected rule (step A9).

In addition, if some or all of the nodes included in the portion that matches the selected rule do not match the nodes of the corresponding first data flow information (step A8: No), the analysis unit 13 determines that there is a risk in the second system 30, but the usage situation is different from that of the first system 1, and associates “NA” with the selected rule (step A10).

Next, when collation of all of the rules is completed (step A11: Yes), the analysis unit 13 generates second analysis result information based on the detection results (step A12). In addition, when collation of all of the rules is not completed (step A11: No), the analysis unit 13 selects a new rule for the processing in step A3.

### MODIFIED EXAMPLE

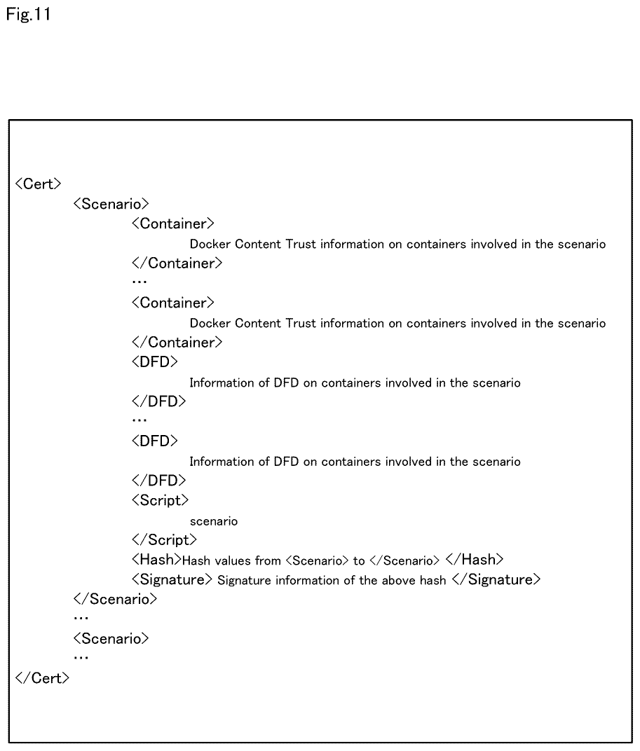

Furthermore, as a modified example, the risk analysis apparatus 20 of the developer may be provided with a function of generating security ensuring information. FIG. 11 is a diagram for describing an example of security ensuring information.

FIG. 11 shows security ensuring information stated in the Docker language. Statement of the test code in FIG. 11 is partially omitted for ease of description.

The security ensuring information in FIG. 11 is created for each scenario. In the example in FIG. 11, security ensuring information includes container information, first data flow information, scenario information, hash information, and signature information.

The container information is information related to a container used for the first system 1 or the second system 30. In the example in FIG. 11, the container information (for example, Docker Content Trust information) is stated between <Container> and </Container>. In addition, the first data flow information of the first system 1 is stated between <DFD> and </DFD>. In addition, the scenario information is stated between <Script> and </Script>. In addition, hash information (hash value from <Scenario> to </Scenario>) is stated between <Hash> and </Hash>. In addition, signature information of hash information is stated between <signature> and </signature>.

### Effects in Example Embodiment

As described above, in the example embodiment, by using the scenario information and the rule information used for the first system, risk analysis conducted in the first system can be reconducted for the second system.

In addition, by comparing the first analysis result information of the developer with the second analysis result information of the transfer destination, it is possible to detect the first system having been modified in the transfer destination or a method for using the system having been changed.

In addition, if it is determined that there is a risk in the second system (analysis result is NG), it is possible to clarify which is responsible, the developer or the transfer destination. As a result, the security quality of the second system can be ensured.

### Program

The program according to the embodiment may be a program that causes a computer to execute steps A1 to A10 shown in FIG. 10. By installing this program in a computer and executing the program, the security ensuring apparatus and the security ensuring method according to the example embodiment can be realized. In this case, the processor of the computer performs processing to function as the obtaining unit 11, the control unit 14, the generation unit 12, an analysis unit 13, and the examination unit 15.

Also, the program according to the embodiment may be executed by a computer system constructed by a plurality of computers. In this case, for example, each computer may function as any of the obtaining unit 11, the control unit 14, the generation unit 12, an analysis unit 13, and the examination unit 15.

### Physical Configuration

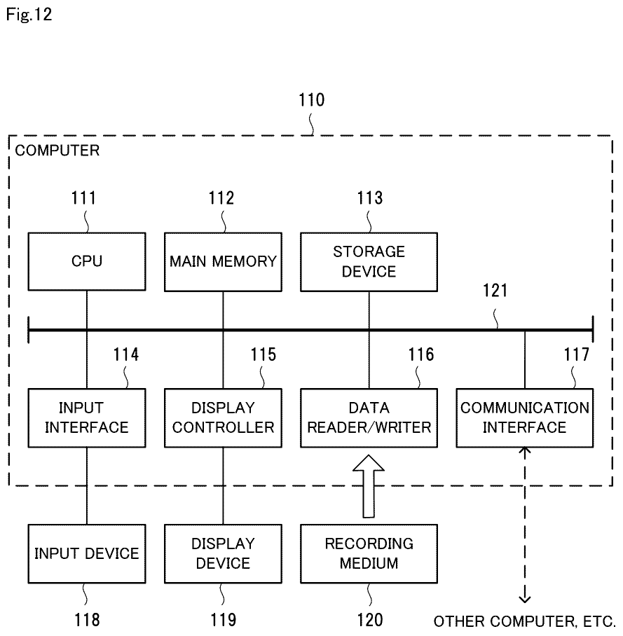

Here, a computer that realizes a security ensuring apparatus by executing the program according to an example embodiment will be described with reference to FIG. 12. FIG. 12 is a block diagram showing an example of a computer that realizes the security ensuring apparatus according to an example embodiment.

As shown in FIG. 12, a computer 110 includes a CPU (Central Processing Unit) 111, a main memory 112, a storage device 113, an input interface 114, a display controller 115, a data reader/writer 116, and a communications interface 117. These units are each connected so as to be capable of performing data communications with each other through a bus 121. Note that the computer 110 may include a GPU (Graphics Processing Unit) or an FPGA (Field-Programmable Gate Array) in addition to the CPU 111 or in place of the CPU 111.

The CPU 111 opens the program (code) according to this example embodiment, which has been stored in the storage device 113, in the main memory 112 and performs various operations by executing the program in a predetermined order. The main memory 112 is typically a volatile storage device such as a DRAM (Dynamic Random Access Memory). Also, the program according to this example embodiment is provided in a state being stored in a computer-readable recording medium 120. Note that the program according to this example embodiment may be distributed on the Internet, which is connected through the communications interface 117. Note that the computer-readable recording medium 120 is a non-volatile recording medium.

Also, other than a hard disk drive, a semiconductor storage device such as a flash memory can be given as a specific example of the storage device 113. The input interface 114 mediates data transmission between the CPU 111 and an input device 118, which may be a keyboard or mouse. The display controller 115 is connected to a display device 119, and controls display on the display device 119.

The data reader/writer 116 mediates data transmission between the CPU 111 and the recording medium 120, and executes reading of a program from the recording medium 120 and writing of processing results in the computer 110 to the recording medium 120. The communications interface 117 mediates data transmission between the CPU 111 and other computers.

Also, general-purpose semiconductor storage devices such as CF (Compact Flash (registered trademark)) and SD (Secure Digital), a magnetic recording medium such as a Flexible Disk, or an optical recording medium such as a CD-ROM (Compact Disk Read-Only Memory) can be given as specific examples of the recording medium 120.

Also, instead of a computer in which a program is installed, the security ensuring apparatus 10 according to this example embodiment can also be realized by using hardware corresponding to each unit. Furthermore, a portion of the security ensuring apparatus 10 may be realized by a program, and the remaining portion realized by hardware.

### Supplementary Note

Furthermore, the following supplementary notes are disclosed regarding the example embodiments described above. Some portion or all of the example embodiments described above can be realized according to (supplementary note 1) to (supplementary note 12) described below, but the below description does not limit the present invention.

### Supplementary Note 1

A security ensuring apparatus comprising:
an obtaining unit that obtains scenario information generated in order to detect a risk in a first system, first data flow information generated based on first history information obtained by an agent of the first system and indicating a flow of data in the first system, rule information for performing risk analysis on the first data flow information, and first analysis result information indicating a result of risk analysis on the first system;
a generation unit that generates second data flow information indicating a flow of data in a second system based on second history information obtained by the agent, after an attack is executed on the second system based on the scenario information; and
an analysis unit that performs risk analysis using the second data flow information and the rule information.

### Supplementary Note 2

The security ensuring apparatus according to Supplementary Note 1,
wherein the analysis unit collates the rule information and the second data flow information with each other, and determines that there is no risk in the second system with respect to the rule information if no portion of the second data flow information matches the rule information, and determines that there is the possibility of a risk in the second system with respect to the rule information if a portion of the second data flow information matches the rule information.

### Supplementary Note 3

The security ensuring apparatus according to Supplementary Note 2,
wherein, if it is determined that there is the possibility of a risk in the second system with respect to the rule information, and entire node information included in data flow information of the matched portion matches node information of the corresponding first data flow information, the analysis unit determines that there was a risk in the first system with respect to the rule information.

### Supplementary Note 4

The security ensuring apparatus according to Supplementary Note 2 or 3,
wherein, if it is determined that there is the possibility of a risk in the second system with respect to the rule information, and a portion or the entirety of the node information included in the data flow information of the matched portion does not match the node information of the corresponding first data flow information, the analysis unit determines that there is a risk in the second system with respect to the rule information.

### Supplementary Note 5

A security ensuring method that is performed by a computer, comprising:
obtaining scenario information generated in order to detect a risk in a first system, first data flow information generated based on first history information obtained by an agent of the first system and indicating a flow of data in the first system, rule information for performing risk analysis on the first data flow information, and first analysis result information indicating a result of risk analysis on the first system;
generating second data flow information indicating a flow of data in a second system based on second history information obtained by the agent, after an attack is executed on the second system based on the scenario information; and
performing risk analysis using the second data flow information and the rule information.

### Supplementary Note 6

The security ensuring method according to Supplementary Note 5,
wherein, in risk analysis, the rule information and the second data flow information are collated with each other, and it is determined that there is no risk in the second system with respect to the rule information if no portion of the second data flow information matches the rule information, and it is determined that there is the possibility of a risk in the second system with respect to the rule information if a portion of the second data flow information matches the rule information.

### Supplementary Note 7

The security ensuring method according to Supplementary Note 6,
wherein, in risk analysis, if it is determined that there is the possibility of a risk in the second system with respect to the rule information, and entire node information included in data flow information of the matched portion matches node information of the corresponding first data flow information, it is determined that there was a risk in the first system with respect to the rule information.

### Supplementary Note 8

The security ensuring method according to Supplementary Note 6 or 7,
wherein, in risk analysis, if it is determined that there is the possibility of a risk in the second system with respect to the rule information, and a portion or the entirety of the node information included in the data flow information of the matched portion does not match the node information of the corresponding first data flow information, it is determined that there is a risk in the second system with respect to the rule information.

### Supplementary Note 9

A computer-readable recording medium that includes a program recorded thereon, the program including instructions that cause the computer to carry out:
obtaining scenario information generated in order to detect a risk in a first system, first data flow information generated based on first history information obtained by an agent of the first system and indicating a flow of data in the first system, rule information for performing risk analysis on the first data flow information, and first analysis result information indicating a result of risk analysis on the first system:
generating second data flow information indicating a flow of data in a second system based on second history information obtained by the agent, after an attack is executed on the second system based on the scenario information; and
performing risk analysis using the second data flow information and the rule information.

### Supplementary Note 10

The computer-readable recording medium according to Supplementary Note 9,
wherein, in risk analysis, the rule information and the second data flow information are collated with each other, and it is determined that there is no risk in the second system with respect to the rule information if no portion of the second data flow information matches the rule information, and it is determined that there is the possibility of a risk in the second system with respect to the rule information if a portion of the second data flow information matches the rule information.

### Supplementary Note 11

The computer-readable recording medium according to Supplementary Note 10,
wherein, in risk analysis, if it is determined that there is the possibility of a risk in the second system with respect to the rule information, and entire node information included in data flow information of the matched portion matches node information of the corresponding first data flow information, it is determined that there was a risk in the first system with respect to the rule information.

### Supplementary Note 12

The computer-readable recording medium according to Supplementary Note 10 or 11,
wherein, in risk analysis, if it is determined that there is the possibility of a risk in the second system with respect to the rule information, and a portion or the entirety of the node information included in the data flow information of the matched portion does not match the node information of the corresponding first data flow information, it is determined that there is a risk in the second system with respect to the rule information.

Although the present invention of this application has been described with reference to exemplary embodiments, the present invention of this application is not limited to the above exemplary embodiments. Within the scope of the present invention of this application, various changes that can be understood by those skilled in the art can be made to the configuration and details of the present invention of this application.

### INDUSTRIAL APPLICABILITY

As described above, the risk analysis performed by the developed system can be reconducted on a system additionally developed at a transfer destination. It is also useful in fields where attack analysis is necessary.

### LIST OF REFERENCE SIGNS

1 First system
2 Agent
3 Developer network
10 Security ensuring apparatus
11 Obtaining unit
12, 22 Generation unit
13, 23 Analysis unit
14, 21 Control unit
15 Display controller
20, 20′Risk analysis apparatus
30 Second system
31 Agent
32 Transfer destination network
40 Storage device
100 System
110 Computer
111 CPU
112 Main memory
113 Storage device
114 Input interface
115 Display controller
116 Data reader/writer
117 Communications interface
118 Input device
119 Display device
120 Recording medium
121 Bus

What is claimed is:

1. A security ensuring apparatus comprising:
at least one memory storing instructions; and
at least one processor configured to execute the instructions to:
obtain scenario information generated in order to detect a risk in a first system, first data flow information generated based on first history information obtained by an agent of the first system and indicating a flow of data in the first system, rule information for performing risk analysis on the first data flow information, and first analysis result information indicating a result of risk analysis on the first system;
generate second data flow information indicating a flow of data in a second system based on second history information obtained by the agent, after an attack is executed on the second system based on the scenario information; and
perform risk analysis using the second data flow information and the rule information.

2. The security ensuring apparatus according to claim 1,
wherein, in risk analysis, the rule information and the second data flow information are collated with each other, and determines determine that there is no risk in the second system with respect to the rule information if no portion of the second data flow information matches the rule information, and determine that there is the possibility of a risk in the second system with respect to the rule information if a portion of the second data flow information matches the rule information.

3. The security ensuring apparatus according to claim 2,
wherein, in risk analysis, if it is determined that there is the possibility of a risk in the second system with respect to the rule information, and entire node information included in data flow information of the matched portion matches node information of the corresponding first data flow information, determine that there was a risk in the first system with respect to the rule information.

4. The security ensuring apparatus according to claim 2,
wherein, in risk analysis, if it is determined that there is the possibility of a risk in the second system with respect to the rule information, and a portion or the entirety of the node information included in the data flow information of the matched portion does not match the node information of the corresponding first data flow information, determine that there is a risk in the second system with respect to the rule information.

5. A security ensuring method that is performed by a computer, comprising:
obtaining scenario information generated in order to detect a risk in a first system, first data flow information generated based on first history information obtained by an agent of the first system and indicating a flow of data in the first system, rule information for performing risk analysis on the first data flow information, and first analysis result information indicating a result of risk analysis on the first system;
generating second data flow information indicating a flow of data in a second system based on second history information obtained by the agent, after an attack is executed on the second system based on the scenario information; and
performing risk analysis using the second data flow information and the rule information.

6. The security ensuring method according to claim 5,
wherein, in risk analysis, the rule information and the second data flow information are collated with each other, and it is determined that there is no risk in the second system with respect to the rule information if no portion of the second data flow information matches the rule information, and it is determined that there is the possibility of a risk in the second system with respect to the rule information if a portion of the second data flow information matches the rule information.

7. The security ensuring method according to claim 6,
wherein, in risk analysis, if it is determined that there is the possibility of a risk in the second system with respect to the rule information, and entire node information included in data flow information of the matched portion matches node information of the corresponding first data flow information, it is determined that there was a risk in the first system with respect to the rule information.

8. The security ensuring method according to claim 6,
wherein, in risk analysis, if it is determined that there is the possibility of a risk in the second system with respect to the rule information, and a portion or the entirety of the node information included in the data flow information of the matched portion does not match the node information of the corresponding first data flow information, it is determined that there is a risk in the second system with respect to the rule information.

9. A non-transitory computer-readable recording medium that includes a program recorded thereon, the program including instructions that cause the computer to carry out:
obtaining scenario information generated in order to detect a risk in a first system, first data flow information generated based on first history information obtained by an agent of the first system and indicating a flow of data in the first system, rule information for performing risk analysis on the first data flow information, and first analysis result information indicating a result of risk analysis on the first system:
generating second data flow information indicating a flow of data in a second system based on second history information obtained by the agent, after an attack is executed on the second system based on the scenario information; and
performing risk analysis using the second data flow information and the rule information.

10. The non-transitory computer-readable recording medium according to claim 9,
wherein, in risk analysis, the rule information and the second data flow information are collated with each other, and it is determined that there is no risk in the second system with respect to the rule information if no portion of the second data flow information matches the rule information, and it is determined that there is the possibility of a risk in the second system with respect to the rule information if a portion of the second data flow information matches the rule information.

11. The non-transitory computer-readable recording medium according to claim 10,
wherein, in risk analysis, if it is determined that there is the possibility of a risk in the second system with respect to the rule information, and entire node information included in data flow information of the matched portion matches node information of the corresponding first data flow information, it is determined that there was a risk in the first system with respect to the rule information.

12. The non-transitory computer-readable recording medium according to claim 10,
wherein, in risk analysis, if it is determined that there is the possibility of a risk in the second system with respect to the rule information, and a portion or the entirety of the node information included in the data flow information of the matched portion does not match the node information of the corresponding first data flow information, it is determined that there is a risk in the second system with respect to the rule information.
